(19) United States
(12) Patent Application Publication
(10) Pub. No.: US 2008/0266452 A1
(43) Pub. Date: Oct. 30, 2008

(54) MULTI-MEDIA DEVICE

(75) Inventor: SHEN-FU TSAI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/925,274

(22) Filed: Oct. 26, 2007

(30) Foreign Application Priority Data
Apr. 27, 2007 (CN) 200710200531.5

(51) Int. Cl. H04N 9/475; H04N 7/00

(52) U.S. Cl. 348/515; 348/552

(57) ABSTRACT

A multi-media device (100) for processing data includes a multi-media unit (101), a data unit (106) and a data processing unit (108). The multi-media unit is configured for coding sound-waves to audio data and light-waves to video data, and encoding audio data to play sound and video data to play pictures. An adjustable audio/video (AV) data latency function is pre-built in the multi-media unit for adjusting input/output of the AV data. The data unit is configured for reading and storing audio data and video data. The data processing unit is configured for outputting the audio data and video data to the multi-media unit and inputting audio data and video data to the data unit in response to the adjustable AV data latency function.

### BACKGROUND

1. Field of the Invention

The present invention relates to multi-media technology and, particularly, to a multi-media device that make audiences feel sense of distance.

2. Description of Related Art

In nature, light goes much faster than sound. People knew this long time ago from firstly seeing the lightning and then hearing the thunder. By judging time difference between seeing and hearing, people may calculate distance from the lightning. In multi-media technical field, generally, audiences see the lightning and hear the thunder at the same time. However, this departs from the order of nature people know.

What is needed, therefore, is to provide a multi-media device in which the above problem is eliminated or at least alleviated.

### SUMMARY

In a present embodiment, a multi-media device for processing data includes a multi-media unit, a data unit, and a data processing unit. The multi-media unit is configured for coding sound-waves to audio data and light-waves to video data, and encoding audio data to play sound and video data to play pictures. An adjustable audio/video (AV) data latency function is pre-built in the multi-media unit for adjusting input/output of the AV data. The data unit is configured for reading and storing audio data and video data. The data processing unit is configured for outputting the audio data and video data to the multi-media unit and inputting audio data and video data to the data unit in response to the adjustable AV data latency function.

Advantages and novel features will become more apparent from the following detailed description of the present multi-media device, when taken in conjunction with the accompanying drawings.

### BRIEF DESCRIPTION OF THE DRAWINGS

Many aspects of the present multi-media device can be better understood with reference to the following drawings. The components in the drawings are not necessarily drawn to scale, the emphasis instead being placed upon clearly illustrating the principles of the present multi-media device. Moreover, in the drawings, like reference numerals designate corresponding parts throughout the several views.

FIG. 1 is a block diagram of software function modules of a multi-media device according to a first present embodiment;

FIG. 2 is a block diagram of software function modules of a multi-media device according to a second present embodiment; and

FIG. 3 is a block diagram of software function modules of a multi-media device according to a third present embodiment.

Corresponding reference characters indicate corresponding parts throughout the drawings. The exemplifications set out herein illustrate at least one preferred embodiment of the present multi-media device, in one form, and such exemplifications are not to be construed as limiting the scope of the invention in any manner.

### DETAILED DESCRIPTION OF EMBODIMENTS

Reference will now be made to the drawings to describe preferred embodiments of the present multi-media device.

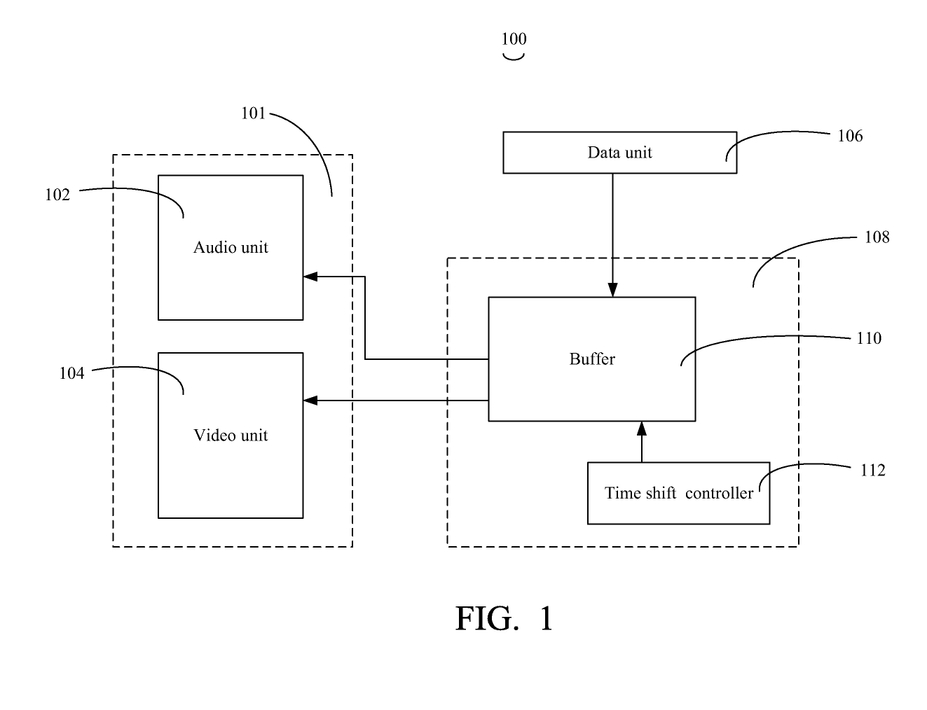

Referring to FIG. 1, a multi-media device 100, according to a first present embodiment, is shown. The multi-media device 100 includes a data unit 106, a multi-media unit 101, and a data processing unit 108. The data unit 106 is configured for reading data (including audio and video) from a storage media (not shown). The multi-media unit 101 includes an audio unit 102 and a video unit 104. The audio unit 102 is configured for encoding audio data to play sound. The video unit 104 is configured for encoding video data to play pictures. The data processing unit 108 includes a buffer 110 and a time shift controller 112. An adjustable audio/video (AV) data latency function is pre-built in the time shift controller 112 for adjusting output of the AV data. The data processing unit 108 is configured for outputting the audio data and video data to the multi-media unit 101 in response to the first adjustable AV data latency function.

In this present embodiment, the data unit 106 includes a CD (compact disc) driver for reading data from a compact disc. The audio unit 102 includes a speaker for playing sound, and the video unit 104 includes a display for displaying pictures.

When the multi-device 100 works, the data unit 106 reads audio data and video data from the compact disc and temporarily stores the audio data and the video data in the buffer 110 of the data processing unit 108. The data processing unit 108 firstly outputs the video data to the video unit 104 and then outputs the audio data to the audio unit 102 in response to the first adjustable AV data latency function pre-built in the time shift controller 112. In other words, audio output is delayed. The video unit 104 encodes the video data so as to display and play pictures, and the audio unit 102 encodes the audio data so as to play sound. In this way, the audiences may see the pictures ahead of hearing the accompanied sound. Thus, the audiences can feel a sense of distance.

The first adjustable AV date latency function built in the time shift controller 112 is determined by the audience or manufacturer or distance between the audience and the multi-media device 100. If the first adjustable AV date latency function built in the time shift controller 112 is determined by distance between the audience and the multi-media device 100, the multi-media device 100 further includes a distance detector (e.g., an infrared distance detector). The distance detector detects the distance between the audiences and the multi-media device 100.

For example, the data include information of an explosion event, i.e., the video data include information of explosion pictures and the audio data includes information of accompanied explosion sound. The data processing unit 108 outputs the audio data to the audio unit 102 later than outputting the video data to the video unit 104 in response to the first adjustable AV date latency function. Thus, exciting events in an action movie for example, such as an explosion, can be made more realistic by first showing video of the explosion then playing sounds of the explosion after an appropriate delay. In this way, the audiences can feel a sense of distance.

It is understood that the multi-media device 100 may also work as following. If the multi-media device 100 is far from the audience, the data processing unit 108 firstly outputs the audio data to the audio unit 102 and then outputs the video data to the video unit 104. Thus, compensation is made for the distance between the multi-media device 100 and the audience. For example, if the distance between the multi-media device 100 and the audiences is 34 meters, and we know that the speed of sound is about 340 meters per second, then in order for the audience to see light (understood as pictures) and hear sound at the same time in a movie for example, the data processing unit 108 outputs the video data to the video unit 104 after about a 0.1 second delay relative to the time the data processing unit 108 outputs the audio data to the video unit 102.

The buffer 110 may be a dynamic random-access memory (DRAM) for storing audio data and vide data, and the time shift controller 112 may be a central processing unit (CPU). The adjustable AV data latency function is pre-programmed inside the CPU. The data processing unit 108 outputs the audio data and video data to the multi-media unit 101 in response to the first adjustable AV data latency function of the CPU.

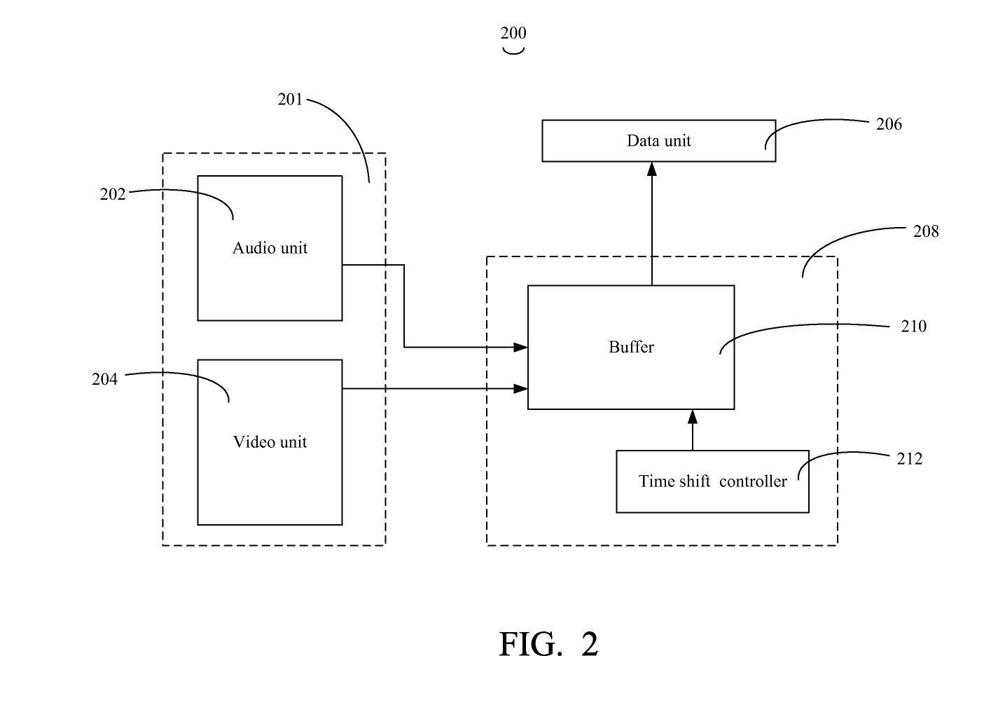

Referring to FIG. 2, a multi-media device 200, in response to a second present embodiment, is shown. Differences between the multi-media device 200 in this present embodiment and the multi-media device 100 in the first present embodiment are that an audio unit 202 of a multi-media unit 201 is configured for coding sound-waves to audio data, and a video unit 204 of the multi-media unit 201 is configured for coding light-waves to video data. A data unit 206 is configured for storing data in a storage media.

In this present embodiment, the audio unit 202 includes a microphone for capturing and coding sound-waves to audio data, and the video unit 204 includes a camera module for capturing and coding light-waves to video data, and the data unit 206 includes a hard disk for storing audio data and video data therein. A time shift controller 212 has a preset adjustable AV date latency function built therein.

When the multi-media device 200 is recording, the audio unit 202 captures and codes sound-waves to audio data, and the video unit 204 captures and codes light-waves to video data. The audio data and the video data are temporarily stored in the buffer 210 of the data processing unit 208. The audio unit 202 captures and codes user's sound to audio data while the video unit 204 captures and codes user's movement to video data. The data processing unit 208 firstly outputs the video data to the data unit 206 and then the audio data to the data unit 206 from the buffer 210 in response to the second adjustable AV date latency function pre-built in the time shift controller 212. Therefore, the audio data and the video data are stored in the hard disk non-synchronously. When the record is played, the data are decoded to play sound and pictures. Since the audio data and the video data are stored in the hard disk non-synchronously, the resultant effect is that the audience can feel sense of greater distance than the actual distance during recording.

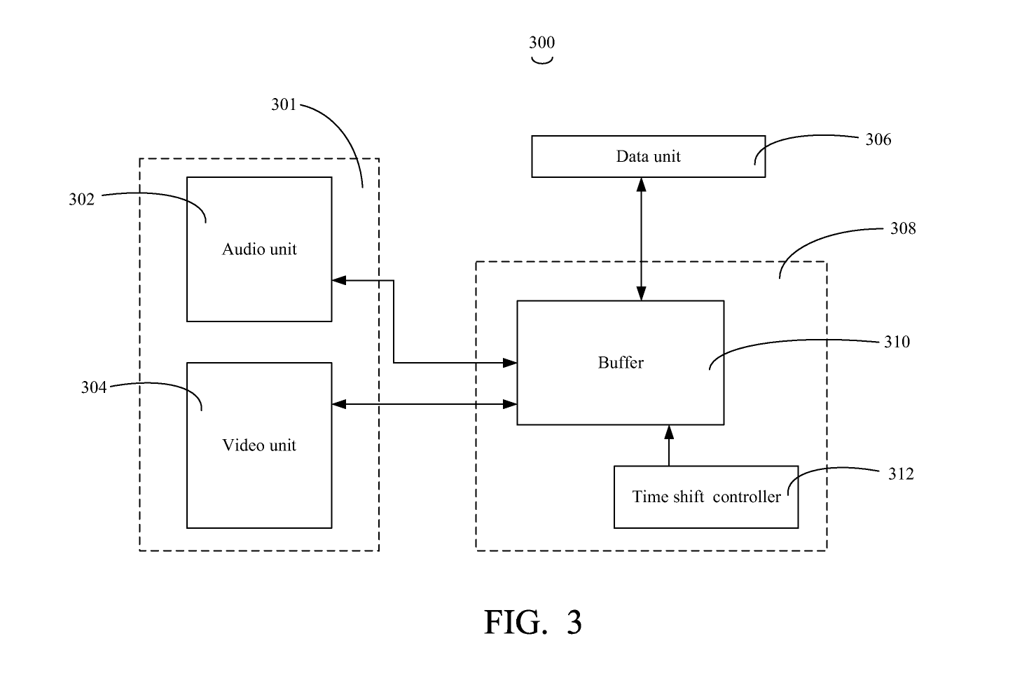

Referring to FIG. 3, a multi-media device 300, according to a third present embodiment, is shown. The multi-media device 300 includes a data unit 306, a multi-media unit 301, and a data processing unit 308. The data unit 306 is configured for reading data (including audio and video) from a storage media (not shown) and writing data to the storage media. The multi-media unit 301 includes an audio unit 302 and a video unit 104. The audio unit 302 is configured for encoding audio data to play sound and coding sound-waves to audio data. The video unit 304 is configured for encoding video data to play pictures and coding light-waves to video data. The data processing unit 308 includes a buffer 310 and a time shift controller 312. A third adjustable AV date latency function is pre-built in the time shift controller 312.

It is understood that the audio unit 302 includes a speaker and a microphone. The video unit 304 includes a camera module and a display. The data unit 306 includes a CD driver and a hard disk.

When the multi-media device 300 is playing, the data processing unit 308 firstly outputs the video data to the video unit 304 and then outputs the audio data to the audio unit 302 in response to the third adjustable AV data latency function pre-built in the time shift controller 312. In other words, audio output is delayed. The video unit 304 encodes the video data so as to display and play pictures, and the audio unit 302 encodes the audio data so as to play sound. In this way, the audiences may see the pictures ahead of hearing the accompanied sound. Thus, the audiences can feel a sense of distance.

When the multi-media device 300 is recording, the audio unit 302 captures and codes sound-waves to audio data, and the video unit 304 captures and codes light-waves to video data. The audio data and the video data are temporarily stored in the buffer 310 of the data processing unit 308. The audio unit 302 captures and codes user's sound to audio data while the video unit 304 captures and codes user's movement to video data. The data processing unit 308 firstly outputs the video data to the data unit 306 and then the audio data to the data unit 306 from the buffer 310 in response to the third adjustable AV date latency function pre-built in the time shift controller 312. Therefore, the audio data and the video data are stored in the hard disk non-synchronously. When the record is played, the data are decoded to play sound and pictures. Since the audio data and the video data are stored in the hard disk non-synchronously, the resultant effect is that the audience can feel sense of greater distance than the actual distance during recording.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A multi-media device for processing data, comprising:
a multi-media unit configured for coding sound-waves to audio data and light-waves to video data, and encoding audio data to play sound and video data to play pictures, an adjustable audio/video (AV) data latency function being pre-built in the multi-media unit for adjusting input/output of the AV data;
a data unit configured for reading and storing audio data and video data; and
a data processing unit configured for outputting the audio data and video data to the multi-media unit and inputting audio data and video data to the data unit in response to the adjustable AV data latency function.

2. The multi-media device as claimed in claim 1, wherein the adjustable AV data latency function includes a first adjustable AV data latency function and a second adjustable AV data latency function; the data processing unit outputs the audio data and video data to the multi-media unit in response to the first adjustable AV data latency function, and storing audio data and video data to the data unit in response to the second adjustable AV data latency function.

3. The multi-media device as claimed in claim 1, wherein the multi-media unit includes an audio unit for coding sound-waves to audio data and encoding audio data to play sound, and a video unit for coding light-waves to video data and encoding video data to play pictures.

4. The multi-media device as claimed in claim 1, wherein the data processing unit includes a buffer and a time shift controller; the buffer is configured for temporarily storing the audio data and the video data, and the first adjustable AV data latency function and the second adjustable AV data latency function are built into the time shift controller; the data processing unit outputs the audio data and video data from the buffer to the multi-media unit in response to the first adjustable AV data latency function and inputs the audio data and the video data from the buffer to the data unit in response to the second adjustable AV data latency function.

5. The multi-media device as claimed in claim 3, wherein the audio unit includes a speaker and a microphone; the video unit includes a display and a camera module.

6. The multi-media device as claimed in claim 1, wherein the data unit includes a compact-disc driver for reading data and a hard disk for data storage.

7. The multi-media device as claimed in claim 1, further comprising a distance detector.

8. The multi-media device as claimed in claim 7, wherein the distance detector is an infrared distance detector.

9. A multi-media device for processing data, comprising:
a multi-media unit comprising an audio unit configured to code sound-waves to audio data and encode audio data to play sound, and a video unit configured to code light-waves to video data and encode video data to play pictures;
a data processing unit comprising a buffer and a time shift controller connected to the buffer, the buffer being connected to the multi-media unit configured to output the audio data and video data to the multi-media unit or receive the audio data and video data from the multi-media unit; and
a data unit connected to the buffer, configured to store or read the audio data and video data;
wherein adjustable audio/video (AV) data latency function is pre-built in the time shift configured to adjust input/output of the AV data in/from the buffer.

10. The multi-media device as claimed in claim 9, wherein the adjustable AV data latency function comprises a first adjustable AV data latency function, and the data processing unit outputs the audio data and video data to the multi-media unit non-synchronously in response to the first adjustable AV data latency function.

11. The multi-media device as claimed in claim 10, wherein the adjustable AV data latency function comprises a second adjustable AV data latency function, and the data processing unit stores audio data and video data to the data unit non-synchronously in response to the second adjustable AV data latency function.

12. The multi-media device as claimed in claim 9, wherein the data processing unit stores the audio data and video data to the data unit non-synchronously in response to the adjustable AV data latency function.

13. The multi-media device as claimed in claim 9, wherein the buffer is a dynamic random-access memory for storing the audio data and vide data, and the time shift controller is a central processing unit.

14. The multi-media device as claimed in claim 9, wherein the audio unit includes a speaker and a microphone; the video unit includes a display and a camera module.
